(19) United States
(12) Patent Application Publication
(10) Pub. No.: US 2005/0081703 A1
(43) Pub. Date: Apr. 21, 2005

(54) Electroacoustic sustainer for musical instruments

(76) Inventor: Alan Anderson Hoover, Indianapolis, IN (US)

Correspondence Address: Alan Anderson Hoover, 3937 Cranbrook Drive, Indianapolis, IN, 46240, US

(21) Appl. No.: 10/686,745

(22) Filed: Oct. 16, 2003

(51) Int. Cl. G10H 3/18

(52) U.S. Cl. 84/726

(57) ABSTRACT

An electroacoustic-type sustainer is provided for prolonging the vibrations of strings of a stringed musical instrument. The instrument has at least one magnetic pickup means responsive to the vibrations of the strings. The instrument pickup produces an output signal in response to the vibrations of the instrument strings. The sustainer comprises a string driver transducer capable of inducing vibrations in the strings, a sustainer amplifier having an input which accepts the pickup output signal, a control circuit to modify the pickup output signal, and an amplifier circuit which amplifies the pickup output signal to produce a drive signal. The sustainer amplifier has an output, from which the drive signal transfers sufficient energy to the string driver transducer to sustain the vibrations of the strings. The transducer has magnetic symmetry, providing less magnetic radiation than previous designs. The transducer is simple in construction. The transducer has an improved mounting design, for attachment to a musical instrument, and which efficiently coupled transducer vibrations to the instrument body. The transducer has an improved cord routing system. The sustainer has an improved automatic harmonic mode control for changing the harmonic vibration mode of the sustained string vibrations.

### FIELD OF THE INVENTION

This invention relates to the field of musical-instrument sustainers for stringed musical instruments such as guitars, pianos and the like, specifically sustainers of the electroacoustic type, and the performance of these sustainers.

### DESCRIPTION OF PRIOR ART

Sustainers for stringed musical instruments cause the string vibrations to sustain by restoring vibration energy, which naturally dissipates due to friction. At least one U.S. patent for a sustainer was issued before 1900. Sustainers have been commercially available since at least the mid-1970's. Most of those sold are used for electric guitar, but they are not limited to that application.

Musical instruments on which a sustainer can be used typically comprise at least the following elements:
(a) One or more vibrating strings which produce the musical tones of the instrument;
(b) A body on which to support the strings;
(c) One or more electric pickups which convert some of the string vibration energy into pulsating, or alternating electrical voltage at the pickup output in response to the string vibrations.
   Sustainer Elements:

A sustainer for a stringed musical instrument usually comprises at least the following elements:
(1) A controller/amplifier to equalize and amplify the alternating electrical signal from the output of the one or more pickups.
(2) User controls, such as ON/OFF switch, amplifier gain control, and phase reversal control (to change string harmonics); additional signal processing might be present, such as automatic gain control circuitry, frequency and phase equalization circuitry;
(3) A power supply, usually either a dc battery or an ac line-powered supply, which is used to supply electrical energy to the controller/amplifier;
(4) A driver transducer which converts the amplified alternating electrical energy from the sustainer amplifier output into either alternating magnetic energy or pulsating acoustic energy, which is then coupled to the strings to replenish vibration energy to the strings which is normally lost due to friction.
   Prior Art Sustainer Technology:

Most existing sustainers for stringed musical instruments can be classified into two main types: (A) Electromagnetic sustainers; (B) Electroacoustic sustainers. For both types of sustainers, elements (1), (2), and (3) above are similar in function. Most driver transducers (4) are electromagnetic in construction and function, yet they have some distinct differences in the mechanical arrangement of the electromagnetic elements depending on whether the sustainer is of the electromagnetic type or of the electroacoustic type.

Electromagnetic sustainers are so-named because the instrument strings receive excitation directly from the pulsating magnetic field that is produced by the driver transducer. This causes them to vibrate continually until the musician forces the note to stop. Electroacoustic sustainers first convert pulsating magnetic energy into vibrating acoustic energy. The acoustic vibration energy is then transferred to the instrument strings through some part of the musical instrument body, producing sustained vibration. The extra energy conversion causes electroacoustic sustainers to be less efficient than electromagnetic sustainers. Some electric guitar players prefer the electroacoustic type over the electromagnetic type because the former produces sustained string vibration and harmonics in a way that is similar to the feedback sustain that one gets from playing in front of a large, loud guitar amplifier.

Electromagnetic sustainers typically have the controller/amplifier, user controls, and a battery power supply mounted inside the instrument body. The controls (on/off switch, phase reversal switch, gain or drive control potentiometers) are usually mounted directly to the instrument body for easy hand-access by the musician.

Some electroacoustic sustainers have a controller/amplifier, user controls, and an ac-line power supply mounted into an enclosure that is not attached to the instrument body. Typically the box sits on the floor, with foot-operated switches to turn the sustainer on and off and also for reversing the phase of the drive signal.

Transducers for Prior Art Sustainers:

Typical driver transducers for both electromagnetic sustainers and electroacoustic sustainers are similar in that they incorporate one or more coils, each coil being wound around a respective magnetic steel core of some appropriate shape, to form a coil/core assembly. For both types of transducer, the alternating amplified electrical signal that is applied to each coil creates an alternating electrical current of appropriate amplitude. This alternating current then produces a corresponding alternating magnetic flux in the core. The magnetic field alternates in north-seeking and south-seeking magnetic polarity at the ends of each respective core. Also incorporated in both types of sustainers are one or more permanent magnets. It is primarily the arrangement of the permanent magnets with respect to the cores that differentiates the two types of drivers.

Prior Art Electromagnetic Sustainer Example:

A typical prior art magnetic-type sustainer 100 is shown schematically in FIG. 1A. It is attached to body 110 of stringed musical instrument 101 having one or more strings 111. Magnetic sustainer 100 is shown mounted inside the instrument body 110, and is powered by a battery 129. One or more strings 111 are attached to and stretched between supports 120 and 121. Pickup 122 is mounted to body 110 under strings 111. Pickup 122 produces an alternating electrical signal at pickup output 123 in response to string vibrations. Sustainer amplifier 124 amplifies the voltage and current at pickup output 123. String driver transducer 130 is mounted to body 110 under strings 111 at an appropriate distance from pickup 122. Output 126 of amplifier 124 is connected to coil 131 of transducer 130. Permanent magnet 134 is attached to magnetic core 132. Coil 131 is wound around magnetic core 132. Permanent magnet 134 is depicted to have its magnetic north-seeking pole (denoted by the letter “N”) against the steel core. Alternatively, magnet 134 could be reversed in polarity. Permanent magnet 134 produces a magnetic flux in magnetic core 132. Optionally, magnetic core 132 could itself be a permanent magnet, such as alnico. In this case, magnet 134 would not be necessary.

The amplified pickup voltage at amplifier output 126 is applied to coil 131 of driver transducer 130, and produces a current in the coil. The alternating magnetic field produced by the current in the coil adds to the steady field produced by the permanent magnetic flux in core 132. The sum of the steady and alternating magnetic fields results in a field of pulsating strength being radiated by the core. Permanent magnet 134 is chosen to have characteristics such that the alternating flux produced by the coil 131 will not demagnetize the magnet. Also, the magnetic strength of the permanent magnet is chosen to be sufficient that when the steady field adds to the alternating field produced by the current in the coil, the total field radiated by the core does not reverse in polarity. Rather, the field that is radiated by each end of the core pulsates in strength but maintains the same polarity as the current through the respective coil alternates in polarity.

In the case of electromagnetic sustainers, the function of the permanent magnet or magnets in the driver is therefore to provide a steady magnetic field to attract the instrument strings to the core or cores by magnetic force. The pulsating field that results when adding the alternating magnetic field produced by the current in the coil impinges on the instrument strings. The magnetic attractive force of the field upon strings 111 pulsates in synchronization with the string vibrations. This adds vibration energy to the strings, with the result that their vibration is sustained.

Prior Art Electroacoustic Sustainer Example:

A typical electroacoustic-type sustainer 150 is shown schematically in FIG. 1B. Sustainer amplifier 160 of acoustic-type sustainer is typically, but not necessarily, located external to instrument body 110. Only sustainer driver transducer 170 is attached to body 110 of stringed musical instrument 101. The instrument has one or more strings 111. Strings 111 are attached and stretched between supports 120 and 121. Pickup 122 is mounted to body 110 under strings 111. Pickup 122 can be the common magnetic type, or a piezo or optical type, or any pickup which senses string vibrations and produces an alternating voltage at pickup output 123 in response to string vibrations. Most electric guitars utilize magnetic pickups. Sustainer amplifier 160 amplifies pickup output 123. Controls 163, 164, and 165 are depicted simply as a single block. Controls 163 and 164 comprise switches for turning the sustainer amplifier on and off, and also a phase reversal switch. Control 165 is a potentiometer used to control amplifier gain. Other electronic signal processing controls (not shown) can be used. Amplified alternating voltage at output 162 of amplifier 160 is connected to coil 172 of transducer 170. Coil 172 is wound around magnetic core 176. A sheet of resilient material 178 such as foam rubber is sandwiched between one end of core 176 and one face of permanent magnet 174. In this case, the magnetic south pole (indicated by the letter “S”) is attached to resilient sheet 178. The other face of permanent magnet 174 (N) is attached to an appropriate surface of the body 110 of instrument 101. The poles of the permanent magnet can be reversed. An alternating current is produced in coil 172 in response to alternating voltage at amplifier output 162. This alternating current produces a corresponding magnetic flux of alternating polarity in core 176, which emanates from the ends of the core. The alternating magnetic flux that emanates from the ends of core 176 cyclically attracts and repels the flux from permanent magnet 174 in response to output 162 of amplifier 160. Both core 176 and magnet 174 therefore vibrate due to the alternating magnetic force in response to string vibrations of the instrument. Vibration energy from the magnet is transferred into the instrument body because the magnet is rigidly attached to the body. This vibration energy travels through the body to the strings 111 through one or both supports 120 and 121. In the case of a fretted instrument such as an electric guitar (not shown), most of this vibration energy reaches the strings through the frets. Other acoustic electroacoustic transducer designs, having more than one magnet are known.

In the case of electroacoustic sustainers, the function of the permanent magnet or magnets in the driver is to provide a steady magnetic field that is cyclically attracted and repelled by the magnetic field of alternating polarity that is produced in the core in response to the sustainer amplifier output signal. These pulsating magnetic forces cause mechanical vibration to travel through the instrument body and to transfer to the vibrating strings, thereby keeping them in sustained vibration.

Sustainer Performance Characteristics:

A desirable quality for a musical instrument sustainer for a stringed musical instrument is that it have robust operation. It is the opinion of the inventor that two main properties or quantities make up this quality of sustainer robustness:

(1) Amplitude of sustained string vibration: The sustainer must force the strings to have sufficient sustained vibration amplitude in order for the instrument to produce musical tones at a satisfactory volume level. The sustained vibration amplitude of the strings must be similar to the vibration amplitude that is achieved during normal playing of the instrument. This is a function of the amount of vibration energy that the driver transducer can impart to the strings.

(2) Quickness of sustained string vibration amplitude buildup: The sustainer must be able to force the strings to reach this sustained vibration level quickly, especially if a string is only lightly hammered or tapped with the fingers, or lightly plucked by the musician as might be done when playing an electric guitar. This means that the vibration energy is imparted to the strings very quickly by the driver transducer.

This combination of desirable characteristics will make the sustainer robust because it will make the performance of the sustainer responsive to the musician. This will enable the sustainer to provide maximum benefit to enhance the artistic process of making music.

These two criteria for robustness can be defined more precisely yet very easily and without special measurement tools:

(1) String vibration amplitude: For a typical electric guitar string, “sufficient sustained vibration amplitude” can be approximately quantitatively defined as a “rule of thumb”: The vibration amplitude is measured at the appropriate location on the length of the string where the vibration amplitude is maximum. The measurement location is the middle of the string for a string that is vibrating in the fundamental mode of vibration. For a string that is vibrating in the fundamental mode, the vibration distance that is traveled by the middle of the string should be approximately the same dimension as the respective string diameter, or greater. This measurement of string vibration amplitude, while not exacting, has merit because it is easy to visualize without using measurement instruments, and it corresponds to the approximate vibration amplitude at a time period of about one second after plucking a typical electric guitar string with a normal picking intensity. If a string is vibrating in one of the harmonic modes, then the vibration amplitude is usually less than this “rule-of-thumb”.

The amount of vibration energy that the driver transducer can impart to the strings has a corresponding effect upon the sustained string vibration amplitude. The amplitude of sustained string vibration is dependent on the amount of vibration energy that is emanating from the driver transducer. This amount of vibration energy is related to the amount of electrical energy that is available at the amplifier output to be delivered to the driver, and also to the size of the core, coil, and permanent magnets that make up the driver.

Driver impedance tends to be inductive. Magnetic energy that radiates from the driver can be increased by increasing power supply voltage to the sustainer amplifier. Also, decreasing driver inductance increases driver magnetic energy in inverse proportion to the square of the inductance.

(2) Sustained vibration quickness: It is desirable to produce the desired sustained vibration amplitude if the string is only lightly plucked, or “hammered-on” to a fret of an instrument such as an electric guitar, such that the string vibration energy increases to the sustained vibration amplitude from some initial lower amplitude of vibration. It is also advantageous if this final sustained vibration amplitude is reached quickly, within a time period of about one or two seconds, or even faster. The ability to produce the final sustained vibration amplitude very quickly has an important factor in the quality and robustness of the sustainer.

A high gain sustainer amplifier will produce a large signal level at the amplifier output in response to a small signal level coming from the pickup. This will cause the driver transducer to impart a large amount of vibration energy into the strings quickly. The amount of time that it takes to reach the sustained vibration amplitude from a rest position corresponds inversely to the amount of vibration energy being produced by the driver.

Problems with Achieving Sustainer Robustness in Prior Art Sustainer Designs:

Both types of sustainers, electromagnetic and electroacoustic, have their own advantages and disadvantages. Each has its own set of design problems, which must be solved to make the system perform in a robust manner. Some problems are common to both types of sustainer. For both types of sustainer, the main design goal is achieving robust operation of the sustainer.

As the controller/amplifier gain and energy output are increased in order to achieve robust operation of the sustainer, the pulsation amplitude of the magnetic field that radiates from the driver transducer increases in proportion. The vibration energy of the string increases during each vibration cycle until equilibrium amplitude is reached.

As the controller/amplifier gain and energy output are increased in order to increase the magnetic radiation from the driver, magnetic crosstalk between the driver and the pickups also increases if the instrument pickup is of the magnetic type. Since most electric guitars utilize magnetic pickups, the pickups produce an output voltage in response to the crosstalk from the driver.

This magnetic crosstalk, if excessive, can cause two objectionable problems: (1) If the sustainer controller/amplifier input is overdriven such that amplifier output clipping occurs, the amplifier output will be distorted. The distorted amplifier output signal will likewise distort the pulsating magnetic field emitted from the driver. The instrument pickups produce an output voltage in response to the distorted magnetic field radiated from the driver. This distortion is then heard from the loudspeaker of the instrument amplifier; (2) If the signal gain of the sustainer controller/amplifier is large (which is a desirable characteristic), and if the amount of driver-to-pickup crosstalk is excessive, then an unstable feedback loop condition can occur. This condition was described for magnetic sustainers in U.S. Pat. No. 4,941,388, Hoover et al. For an acoustic-type sustainer the driver-to-pickup spacing is usually much greater than that of the magnetic-type sustainer, if the transducer is mounted to the headstock of an electric guitar. As driver-to-pickup spacing increases, crosstalk becomes less. However, acoustic-type sustainers are much less efficient than magnetic-type sustainers, because an extra energy conversion must be done. Therefore, acoustic-type sustainers need significantly more amplifier gain and output energy than do magnetic-type sustainers to achieve similar robustness. Thus, this extra amplifier gain makes magnetic crosstalk a substantial problem for electroacoustic-type sustainers as well as for magnetic-type sustainers.

Examples of Prior Art Electroacoustic-Type Sustainer Transducers:

(1) One type of electroacoustic string driver transducer for a sustainer first converts the amplified alternating electric signal coming from the sustainer amplifier into a pulsating magnetic field. Then, due to the construction of the transducer, the pulsating magnetic field is converted into pulsating acoustic vibration energy, which is applied directly to some part of the body of the instrument. The acoustic vibration energy travels through the body to one or both ends of the strings, and is transferred to them. The vibration energy of the strings, which would normally be lost due to friction, is thus restored. The string vibration is thereby sustained.

U.S. Pat. No. 3,449,531, Ashworth, 1969, June describes an electromagnetic transducer having a single coil wound around a bar-shaped core, this assembly being surrounded by a ring magnet that surrounds the assembly such that the axis of magnet and core coincide. A plate is spaced from one end of the core by a sheet of resilient rubber or rubber-like material which is free to vibrate in response to magnetic forces that are produced when an audio signal excites the coil. No sustainer mechanism is described in the '531 patent. However, Ashworth's transducer is specifically described being used in an electroacoustic sustainer in U.S. Pat. No. 4,697,491, Maloney, 1987, Oct. 6. Maloney describes a transducer similar to that of U.S. Pat. No. 3,449,531 being attached to the top of the neck of a stringed instrument such as a guitar, where the drive signal coming from a sustainer amplifier passes through a connector. The connector is attached either to the body of the instrument, or to a clamp which holds the transducer to the top of the neck. This type of transducer is similar to that shown in the sustainer of FIG. 1B.

The inventor has found that an acoustic sustainer using this type of transducer has excessive magnetic crosstalk to the instrument pickups. A sustainer using this type of transducer must have the amplifier set at a too low a gain to produce robust sustainer operation. When amplifier gain is raised to a level where the sustainer operation starts to become robust, magnetic crosstalk produces distortion in the pickup signal, and also uncontrolled oscillation.

Another example of an electroacoustic sustainer is U.S. Pat. No. 4,852,444, Hoover/Osborne, 1989, Aug. 1. This patent describes two different configurations of transducer, as shown in FIG. 2. FIGS. 2A and 2B show electromagnetic transducers 210 and 250 respectively, as described in the '444 patent.

Referring to FIG. 2, musical instrument 101 comprises body 110, one or more strings 111 which vibrate to produce the musical tones of the instrument, pickup 122, which produces an electrical voltage in response to vibrations of strings 111. Sustainer 200 comprises the following elements: Sustainer amplifier 280 amplifies the output of musical instrument pickup 122. Output 282 of amplifier 280 is connected to sustainer electromagnetic transducer 210 (FIG. 2A) or 250 (FIG. 2B).

FIG. 2A shows electroacoustic sustainer 200 with stringed musical instrument 101. Transducer 210 is attached to instrument body 110, and comprises the following: Coil 212 is wound around the middle section of C-shaped core 211. Core ends 216, 218 protrude equal lengths from coil 212. Magnets 222, 224 are mounted to instrument body 110. The magnets are constructed of identical materials, and are of substantially identical size and shape. Magnets 222, 224 are polarized according to the “N”, “S” markings shown in the drawing (or they can both be reversed from that shown as long as both are reversed). The magnets can optionally be mounted to plate 223, preferably made from mild steel, which is then clamped or bonded to instrument body 110. Identical resilient pads 226, 228 are sandwiched between respective magnets 222, 224 and respective core ends 216, 218. Output 282 of sustainer amplifier 280 is connected to coil 212. Current produced in coil 212 in response to output 282 of amplifier 280 produces alternating magnetic flux in the core legs. This flux alternately attracts and repels magnets 222, 224, creating a vibrating force in response to the amplifier output signal. As the current in coil 212 alternates in polarity, magnets 222, 224 vibrate in phase with each other. Resilient pads 226, 228 allow the magnets and core ends to vibrate relative to each other in response to the vibrating magnetic forces. Vibration energy from the electromagnetic transducer reaches the strings through supports 120, 121. In the case of a fretted instrument such as an electric guitar (not shown), the vibration energy from the electromagnetic transducer reaches the strings primarily through the instrument frets (not shown). FIG. 2C shows a perspective view of transducer 210.

In FIG. 2B, C-core transducer 210 is replaced by E-core transducer 250. Transducer coil 252 is wound around center leg 262 of E-shaped core 260. Core end legs 264, 266 and center leg 262 are equal in length. Magnets 240, 242, and 244 are mounted to instrument body 110 such that each magnet is spaced corresponding to a respective core leg 264, 262, and 266. The magnets are polarized as shown, with end legs being similarly polarized, and middle leg having opposite polarity. Optionally, they can have polarities reverse from that shown as long as all are reversed. The magnets can optionally be mounted to plate 273, preferably made from mild steel, which is then clamped or otherwise bonded to instrument body 110. Resilient pad 272 is sandwiched between magnets 240, 242, and 244 and respective ends of core legs 262, 264, and 266. (Separate pads can be used for each magnet, but one pad is more economical to produce.) FIG. 2D shows a perspective view of E-core transducer 250.

Both of these driver designs produce adequate acoustic vibration in instrument body 110 to produce sustained vibrations in instrument strings 111. However, the inventor has found that higher sustainer amplifier gain can be set before uncontrolled oscillation occurs by using a driver constructed as that shown in FIG. 2A than can be achieved using a driver constructed as that shown in FIG. 2B. Therefore, by using a driver as constructed as in FIG. 2A, more robust sustainer performance can be realized than with a driver that is constructed as in FIG. 2B. The sustainer is more responsive for the musician, allowing more expressive performance to be accomplished.

The reason for this is because a driver constructed as that shown in FIG. 2A radiates less magnetic crosstalk into the air than that of FIG. 2B. Consequently, less driver field reaches pickup 122 from the driver in FIG. 2B than from the driver in FIG. 2A. Magnetic crosstalk occurs because a portion of the pulsating magnetic field energy that is radiated by the driver reaches the instrument pickup, and induces a voltage in the pickup coils. As the gain of the sustainer amplifier is increased, magnetic crosstalk increases. If the amount of magnetic crosstalk is high enough, an uncontrolled oscillation results, or the instrument pickup signal can be contaminated with undesired noise or distortion. This is particularly true when the sustainer is used with an electric guitar having single-coil pickups, which have poor rejection of external magnetic fields compared to humbucker-type pickups.

The reason that driver 210 of FIGS. 2A and 2C produces less magnetic crosstalk than that of driver 250 of FIGS. 2B and 2D is because of the arrangement and construction of the magnetic elements. The driver of FIG. 2A has two magnetic core ends 216, 218 that are substantially equal in size and shape, which both protrude equal lengths from coil 212. Furthermore, magnets 222 and 224 are substantially equal in size, shape, and magnetic strength. The design is symmetrical, because the magnetic elements on either side of coil ends 213, 214 of coil 212 are equal in size, shape, and position relative to coil 212. Because of this symmetrical design, the pulsating magnetic fields that radiate from both ends of the driver into free space are approximately equal at all times in intensity and shape, but are opposite in polarity. The resulting effect is that the pulsating magnetic field that radiates from each symmetrical side induces a corresponding pulsating voltage in the instrument pickup 122. However, the two induced voltages are equal in amplitude but 180 degrees out of phase with each other, resulting in zero voltage being induced in pickup 122.

The requirements for zero volts being induced in pickup 122 are:
(A) Both sides of driver 210 which protrude from both sides of coil 213 are substantially identical in size and shape (symmetrical).
(B) Both symmetrical sides of driver 210 are equidistant from pickup 122.

It can be easily seen by inspection of the schematic drawing of FIG. 2A that both symmetrical sides of driver 210 are not shown equidistant from pickup 122. In order to satisfy this condition, the driver must be rotated 90 degrees into the plane of the paper. This detail was purposefully omitted in order to preserve most of the construction details of driver 210 in the schematic drawing. In practice, very good magnetic cancellation can be realized by simply rotating driver 210 and listening to the instrument amplifier for a null in the distortion level to indicate a null in magnetic crosstalk. At this point, the ideal rotation has been achieved and driver 210 is affixed in place.

On the other hand, driver 250 in FIG. 2B is not symmetrical. It can be easily seen that while E-core 260 is symmetrical about a line going through the center of coil 252 along its length, E-core 260 is not symmetrical on either side of coil ends 265, 267. Therefore, the radiated fields generated by alternating current in coil 252 cannot be symmetrical in both shape and intensity.

While driver 210 of FIG. 2A produces less magnetic crosstalk than driver 250 of FIG. 2B, driver 210 is more expensive to produce than that of driver 250. This is because if coil 212 is wound on a bobbin, C-shaped core 211 must comprise two L-shaped pieces (or stacked laminations comprising multiple L-shaped pieces) in order to fit the bobbin onto core 211.

Another way to construct the driver of FIG. 2A would be to use two identical coils (not shown), one wound on leg 216 and the other wound on leg 218, with similar winding direction. The coils could be connected in parallel or series. This would of course be more difficult and more expensive to produce than a single-coil driver as shown in FIG. 2A.

The inventor finds that compared to the design of the improved driver transducer disclosed herein, the magnetic crosstalk of the E-core design of the '444 patent limits robustness of sustainers, when used with an electric guitar having magnetic pickups.

Another example of an electroacoustic type sustainer for a stringed instrument is described in U.S. Pat. No. 3,813,473, Terymenko (Ierymenko), 1974, May 28. The '473 patent describes a sustainer transducer comprising a coil wound around a magnetic core, with a permanent doughnut-shaped magnet pole being attached to one end of the core, similar to that of many loudspeaker magnetic assemblies. The coil is connected to the output terminals of an audio amplifier, the input of which is connected to a string vibration pickup that is mounted onto the instrument. The coil is movable relative to the core, and moves in mechanical vibration in response to an amplifier signal. The vibrating coil is then attached to a bridge on the musical instrument where one end of the strings is attached. Vibration energy is transferred to the strings through the instrument bridge, thus sustaining the vibrations. No detailed discussion of sustainer robustness was given, nor of any attempt to minimize magnetic crosstalk from driver to pickup in order to increase the gain of the sustainer amplifier. Magnetic crosstalk was discussed briefly, but not in any detail other than to say that the driver “coil-magnet combination” must be “out of the inductive range of the pickups.”

(2) Another type of electroacoustic sustainer string driver first converts the amplified alternating electric signal coming from the amplifier into a pulsating magnetic field. Then, due to the mechanical construction of the transducer, the pulsating magnetic field is converted into a pulsating acoustic vibration, which is applied directly to one end of one or more strings of the instrument.

An example of this type of sustainer is U.S. Pat. No. 4,236,433 to Holland, 1980, Dec. 2. Holland mentions shielding the pickup from the driver, but does not offer any other details for reducing magnetic crosstalk from driver to pickup, nor how this might affect sustainer operating quality such as its effectiveness or robustness.

(3) Another type of electroacoustic sustainer string driver utilizes a common cone-type electromagnetic loudspeaker mounted to the body of the instrument, in close proximity to the strings. The loudspeaker first converts the amplified alternating electric signal coming from the amplifier into acoustic airborne vibrations. Then, the vibrating air molecules impinge upon the vibrating strings of the instrument, which restores vibrational energy that would normally be lost due to friction, and thereby sustains the string vibration. Typically, these airborne vibrations impinge upon the strings at some midpoint rather than the ends. In addition, some magnetic energy usually is radiated from the loudspeaker, which also impinges upon the midpoint of the strings, and transfers vibrational energy to the strings. Also, the basket of the loudspeaker vibrates relative to the cone, and transfers some vibrational acoustic energy through the body of the instrument to the ends of the strings. This additional energy may or may not be in phase with the airborne acoustic vibrations.

Examples of this type of sustainer are described in the following U.S. Pat. No. 1,893,895, Hammond, 1929, Jun. 13; U.S. Pat. No. 4,245,540 to Groupp, 1981, Jan. 20; U.S. Pat. No. 4,484,508, Noumey, 1984, Nov. 27; U.S. Pat. No. 3,612,741, Marshall, 1969, Dec. 4. The inventor has found that this type sustainer does not have very robust operation because energy transfer from driver to strings through air is very inefficient. If the amplifier gain is increased to a level where robust sustainer operation begins to be realized, magnetic crosstalk becomes excessive, resulting in uncontrolled oscillation. No details are given in any of these patents for reducing magnetic crosstalk from driver to pickup, nor any details in maximizing sustainer operation or robustness.

From the descriptions given, it can be seen that there is room for improvement in the art of transducer design for electroacoustic sustainers.

Mounting Prior Art Electroacoustic Sustainer Driver Transducers to Stringed Musical Instruments

As described in the above section under “Examples of prior art electroacoustic-type sustainer transducers”, transducers for electroacoustic sustainers must be mounted to some part of the instrument body or string end, so that the acoustic vibrations that are produced by the transducer can be coupled to the instrument strings.

In Ashworth's '531 patent, a screw-type mounting is shown that screws into a mounting surface such as wood. It is generally not desirable to attach screws into the body of a musical instrument, because this does irreversible damage to the instrument body. The Sustainiac Model B owner's manual describes a method of mounting a transducer to an instrument body, whereby a steel plate is attached to the body by glue or screws. The transducer magnets are attached to the plate, and then the rest of the transducer is attached to the magnets.

In the '491 patent, Maloney describes and claims a clamping arrangement for the transducer of Ashworth's '531 patent. Maloney's patent describes and claims a clamp with a sustainer transducer attached to it, an electrical connector attached to the clamp, and electrical wires that connect the transducer to the electrical connector.

FIG. 3: Transducer Cord Routing

An electroacoustic sustainer such as the present invention needs a substantial amount of audio power to drive the transducer. Therefore, the sustainer controller/amplifier is preferably contained in a separate enclosure that contains an audio amplifier that is powered by the ac power line.

For a typical electric stringed instrument such as an electric guitar, the instrument output signal is connected to the input of an amplifier/loudspeaker arrangement, which is used to amplify the instrument output signal so that it can be heard at a suitable volume. The instrument output signal must also be connected to the input of the sustainer amplifier/controller. Then, the sustainer amplifier output signal must be connected to the transducer. Therefore, for a typical arrangement thus described, two electrical cords must be used: One going from the instrument output jack to the sustainer amplifier, and the second going from the sustainer amplifier output jack back to the sustainer driver transducer mounted to the instrument. A third cord goes from the sustainer amplifier to the instrument amplifier, but this third cord does not interfere with the musician like the first two cords do. This arrangement is cumbersome because two electrical cords are attached to the instrument, which must be dealt with by the musician.

In the prior art, several arrangements have been developed to minimize this cumbersome situation. In the '491 patent, Maloney describes an arrangement whereby a headstock-mounted driver transducer can be electrically connected to a connector, which is mounted to the instrument body, and whereby a sustainer amplifier output signal can be also electrically connected to this same connector. While this invention appears to solve some of the problem, the inventor believes that substantial improvement can be made.

A commercial acoustic-type sustainer, the “Sustainiac Model B”, manufactured by Maniac Music Inc., Indianapolis, Ind., was produced and sold from 1987 until 1999. This sustainer used a headstock-mounted driver transducer as described in U.S. Pat. No. 4,852,444, Hoover et al., 1989, Aug. 1. Not described or claimed in the '444 patent, a transducer cord-routing arrangement was described in the owner's manual. Clamps were supplied with the sustainer in order to effect this cord-routing arrangement. This arrangement is depicted in FIG. 3.

FIG. 3 shows transducer 310 mounted to headstock 302 of electric guitar 300. Guitar strap 306 is used to hold the guitar onto the shoulders of the musician. Guitar strap 306 is attached to strap buttons 324, 325. Transducer cord 312 is shown wound through tuning keys 304, looped around upper strap button 324, and through clamps 320. Clamps 320 are adhesive-backed clamps that stick to the back of the body of guitar 300 as shown. Spiral clamps 322 connect transducer cable 312 to first guitar cord 309. First guitar cord 309 connects guitar output 307 to sustainer controller/amplifier 316. Second guitar cord 314 is electrically connected to first guitar cord 309 inside controller/amplifier 316. Second guitar cord 314 carries the guitar pickup signal from the sustainer controller/amplifier to guitar amplifier 311.

This arrangement simplified the task of dealing with two cords coming down from a guitar by joining them together. However, there was reluctance from musicians to use stick-on clamps to guitar bodies. Also, the arrangement of two cables connected together was cumbersome.

FIG. 4: Performance of Prior Art Sustainer Controls

As discussed above, it is desirable for a sustainer to be able to set the instrument strings or other vibratile elements into sustained vibration at sufficient amplitude to provide an adequate volume level. Also, the final sustained vibration amplitude must be reached quickly when desired. These qualities establish the robustness of the sustainer.

Another desirable attribute is for the musician to be able to intentionally and easily change the harmonic mode of vibration of the instrument strings in order to enhance performance. One way to do this is to reverse the electrical phase of the sustainer amplifier output signal with respect to the input signal.

The U.S. Pat. No. 4,852,444 patent describes a musical instrument sustainer phase-changing scheme as shown in FIG. 4. Sustainer 400 is used in conjunction with stringed musical instrument 101. At least one string 111 is attached to instrument body 110, stretched between attachment points 120, 121. Pickup 122 produces output signal 123 in response to string vibrations. Operational amplifier U401 in combination with equal-valued resistors R401, R402, R403 comprise a non-inverting, unity-gain voltage amplifier when S414 is in the open position as shown. When S414 is in closed position, the noninverting (+) terminal of U401 is electrically connected to ground. In this case, U401 becomes unity-gain inverting amplifier.

The signal is further processed by additional circuitry in block 410, which is not shown in order to simplify the explanation. Power amplifier 412 further amplifies voltage and current, and supplies driver transducer 250 with appropriate voltage and current to produce robust sustainer operation.

The prior art Sustainiac Model B sustainer (based on the '444 patent and mentioned above), used such an inverting circuit as shown in FIG. 4 and as described in the '444 patent. In the case of this particular production sustainer, switch S414 was actually an electronic switch that was actuated by a “flip-flop” logic circuit (not shown in FIG. 4). The electronic circuit of this sustainer was housed in a metal box (“floor-box”), which in normal use was placed on the floor. A pair of foot-pedal-actuated switches that were attached to the housing were used to actuate the flip-flop logic circuit. This control arrangement allowed the musician to use both hands to play the instrument, while using a foot to change string vibration harmonics at will by tapping one or the other foot pedal.

While this scheme works well in musical performance, there remain at least two problems:

(A) Often while performing on stage with an electric guitar, the musician moves about on the stage in order to enhance the performance. If it is desired to change the string harmonics while using the sustainer, the musician must remain in the location of the sustainer “floor-box”. This can be an undesirable situation for the performer.

(B) A second problem is that of “dead notes”. As explained in the '444 patent, on a typical electric guitar there will be dead notes that are caused by the sustainer action. The sustainer driver transducer can be mounted to the guitar headstock because it works well there. As the vibration energy is transferred from the transducer to the headstock, it travels down the guitar neck. The vibration energy is coupled into the strings at the points where the strings are pressed against the frets (or the neck, in the case of a fretless guitar), causing the notes to sustain. This point is defined as the “upper string end”. The vibration energy travels to the upper string end at the speed of sound for the particular neck. So, the farther down the neck that notes are fretted, the longer it takes for vibration energy to travel there. This causes phase shift of the transducer driver signal relative to the string vibration. The complex impedance of the instrument pickup itself causes further phase shift as a function of frequency. For some notes, the phase shift of the sustainer output signal arrives at the upper string end precisely out-of-phase with the string vibration. For these notes, the string vibration abruptly stops. This is generally an undesirable condition for the musician. For these notes, the musician must quickly change the sustainer phase by tapping on the appropriate foot-pedal, or memorize the particular notes where this happens and refrain from using them.

One solution to these two problems is to provide a switch that is mounted to the instrument, with wires running down to the floor-box, connecting to the circuit by means of some type of connector. This places the phase-reversal switch at a convenient location at all times. The wires connecting the switch to the floor-box could be located inside the instrument signal cable, in a multi-conductor arrangement. However, this solution has the disadvantage of complicating the instrument with an extra control, and the need of a special instrument signal cable or an extra signal cable.

This arrangement of harmonic controls on a sustainer provided the electric guitar player with a powerful tool to enhance the musical tones produced by an electric stringed instrument. However, the inventor believes that certain control embellishments will enhance and improve the usefulness of the electroacoustic sustainer for musicians. The present sustainer harmonic control provides such enhancement and improves the usefulness of the electroacoustic sustainer for musicians.

### SUMMARY

One aspect of the invention provides an electroacoustic transducer for vibrating part of the body of a musical instrument. The musical instrument body has at least one solid surface on which to mount the transducer. The transducer comprises:
(a) a core made of magnetic steel or other magnetic material, having a shape that is simple and economical to manufacture;
(b) a coil of electrically conductive wire wound around the core, wherein the core protrudes from both ends of the coil such that substantially equal lengths, widths, heights, and shapes of the core protrude from both ends of the coil forming a symmetrical arrangement. The protruding core has two similar faces which face the same direction. One face is on one side of the coil and the other face is on the other side of the coil, comprising two symmetrical core faces;
(d) two sheets of resilient material such as rubber other rubber-like material;
(e) two permanent magnets of substantially equal dimensions and magnetic strength;
(f) a transducer electrical cable which carries a transducer drive signal.

An audio frequency signal source is the transducer drive signal, which produces an alternating current in the coil. This alternating current induces an alternating magnetic flux in the core. Each sheet of resilient material is sandwiched between one said respective core face and one respective permanent magnet pole.

Oppositely polarized magnetic poles are mounted to respective resilient sheets, thus forming a symmetrical arrangement of two equal but oppositely-polarized magnets. Both magnets have limited freedom of movement with respect to their respective core faces due to the resiliency of the resilient sheets that are sandwiched between each magnet and its respective core face.

Both magnets vibrate in response to magnetic forces that result from the magnetic flux that is induced in the core in response to the audio frequency current produced in the coil. The magnetic flux that is induced in the core alternates in polarity in response to the audio frequency current in the coil. Because of the symmetrical arrangement of the equal but oppositely-polarized magnets, both magnets vibrate in synchronization and in a direction that is substantially in parallel.

The opposite two permanent magnet poles from those mounted to the resilient sheets are rigidly attached onto a surface of the body of the musical instrument which is to be vibrated. Therefore, the musical instrument body is vibrated in response to said audio frequency current being produced in said coil. Alternatively, the transducer can be used to vibrate any body of mass.

Another aspect of the invention is a transducer as described above, wherein the two permanent magnet poles opposite from those mounted to the resilient sheets are mounted onto one surface of a plate, and wherein an opposing surface of this plate is rigidly mounted to the body of the musical instrument which is to be vibrated by the transducer. Alternatively, the transducer can be used to vibrate any body of mass.

The aforementioned transducer, wherein the plate is one side of a clamp having two opposing sides, at least one of the two opposing sides being movable so as to firmly clamp a part of a body of the musical instrument or other body of mass between the two opposing sides of the clamp.

Another aspect of the invention is an improved conductor routing system for combining first and second electrical signals through a single multi-conductor electrical cable, wherein the first signal is a musical instrument signal, and the second signal is a transducer drive signal, wherein the function of the transducer is to vibrate a body of the musical instrument, the transducer being mounted to the body of the instrument.

The musical instrument signal is applied to both a musical instrument amplifier which is physically separate from the instrument, and also to the input of an amplifier for an electroacoustic musical instrument sustainer, wherein the amplifier for the sustainer can be physically separate from the musical instrument, wherein the output of the sustainer amplifier is the transducer drive signal.

A first signal conductor which carries the first signal joins to a first conductor of the multi-conductor electrical cable. The second signal cable carrying the second signal joins to a second conductor of the multi-conductor electrical cable. The junctions of the first and second signal conductors to the respective first and second conductors of the multi-conductor cable are attached to the instrument.

Another aspect of the invention modifies the aforementioned conductor routing system, wherein the junctions of the first and second signal conductors to the respective first and second conductors of the multi-conductor cable are attached to a structure that is attached to the instrument.

Another aspect of the invention is a controller/amplifier circuit for a musical instrument sustainer. The musical instrument has at least one vibratile element which produces the sound of the instrument. The instrument also has a pickup for sensing the vibrations of the vibratile elements, wherein the pickup produces a pickup electrical signal in response to vibrations of the vibratile element or elements. The pickup electrical signal is the input signal to the controller/amplifier. The controller/amplifier has at least one amplifier circuit to amplify the pickup signal, and at least one signal processing circuit to process the pickup signal. The controller/amplifier has an output which drives a transducer for the musical instrument sustainer,

One signal processing circuit is an automatic phase reversal circuit. Reversal of the transducer drive signal phase causes a change in vibration harmonics of said vibratile elements of the instrument.

Automatic phase reversal of the signal occurs when the pickup signal amplitude changes from a first amplitude to another, lesser amplitude. The rate of change of the pickup signal amplitude from the first amplitude to the other, lesser amplitude must exceed a predetermined rate of change in order for automatic phase reversal to occur.

Objects and Advantages

Accordingly, objects and advantages of my sustaining device are:

1. To provide an acoustic-type sustainer having an improved driver transducer, resulting in an electroacoustic-type sustainer having a more robust performance than has previously been available. The improvements to the driver transducer are such that less magnetic field reaches the instrument pickup than with previous driver transducers, resulting in less magnetic crosstalk from driver to pickup. Consequently, sustainer amplifier gain can be set to a high level before uncontrolled oscillation occurs, resulting in more robust sustainer performance than has previously been possible. Furthermore, the transducer design is very simple in construction, using common parts, resulting in a very economical design.

2. To provide an acoustic-type sustainer having an improved transducer clamping mechanism that simultaneously provides quick, easy attachment and removal of the driver transducer from the musical instrument, and also provides good vibration energy transfer from the driver transducer to the instrument body or other instrument part;

3. To provide an acoustic-type sustainer having an improved cord routing system for routing the transducer power cord to the sustainer control box and also the guitar signal to the sustainer controller/amplifier that is less cumbersome than the prior art;

4. To provide an acoustic-type sustainer having an automatic circuit to effect phase-reversal of the amplifier signal at the will of the musician, wherein the musician uses a simple manual playing technique to effect the phase reversal, without the necessity of actuating any hand-controlled or foot-controlled electromechanical switch, in order to provide better control of the instrument string harmonics by the musician than has previously been possible.

Further objects and advantages of the invention will become apparent from a consideration of the drawings and ensuing description.

### DRAWING FIGURES

FIG. 1A Prior Art electromagnetic sustainer schematic

FIG. 1B Prior Art electroacoustic sustainer schematic

FIG. 2A Prior Art electroacoustic sustainer schematic

FIG. 2B Prior Art electroacoustic sustainer schematic

FIG. 2C Prior Art electroacoustic sustainer transducer

FIG. 2D Prior Art electroacoustic sustainer transducer

FIG. 3 Prior Art electroacoustic sustainer transducer cord routing system

FIG. 4 Prior Art sustainer schematic, showing phase reversal circuit

FIG. 5A Electroacoustic sustainer schematic

FIG. 5B Improved transducer for electroacoustic sustainer, perspective view

FIG. 5C Improved transducer for electroacoustic sustainer with clamp, front view

FIG. 5D Improved transducer for electroacoustic sustainer with clamp, side view

FIG. 5E Improved transducer for electroacoustic sustainer with clamp, side view

FIG. 5F Improved transducer for electroacoustic sustainer with clamp, side view

FIG. 5G Improved transducer for electroacoustic sustainer with clamp, side view

FIG. 5H Improved transducer for electroacoustic sustainer with clamp, side view

FIG. 6A Improved cord routing system for electroacoustic sustainer

FIG. 6B Improved cord routing system for electroacoustic sustainer, schematic

FIG. 7A Improved electroacoustic sustainer controller/amplifier electrical schematic

FIG. 7B Waveforms for improved electroacoustic sustainer controller/amplifier

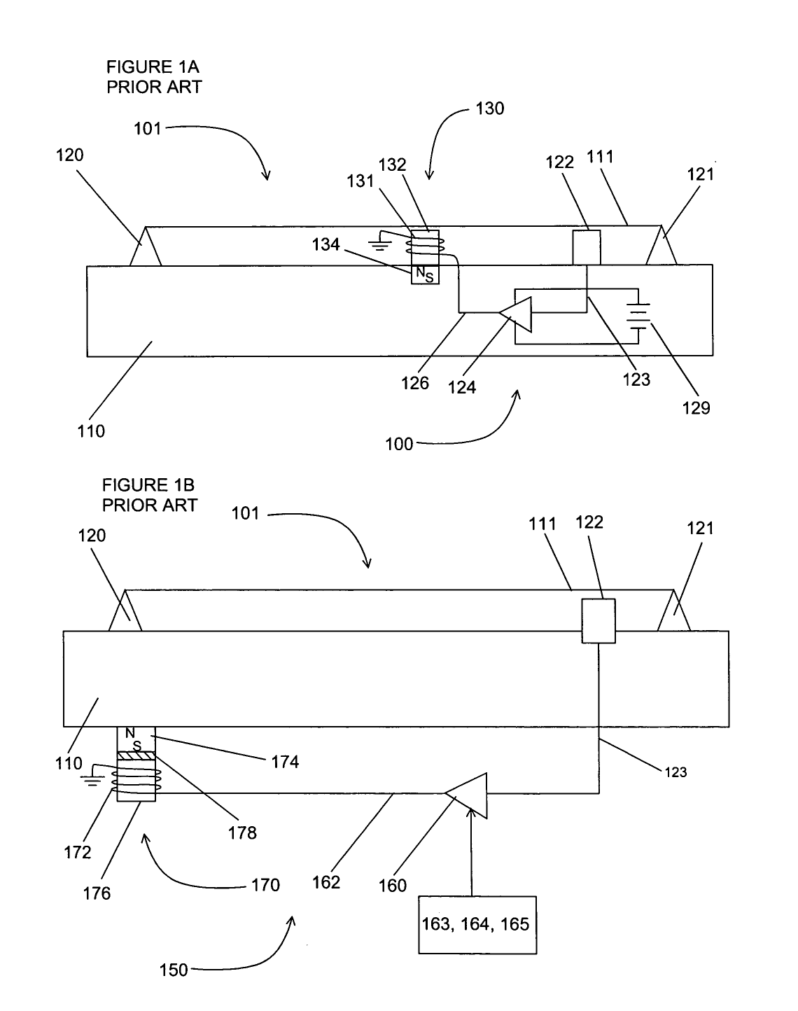

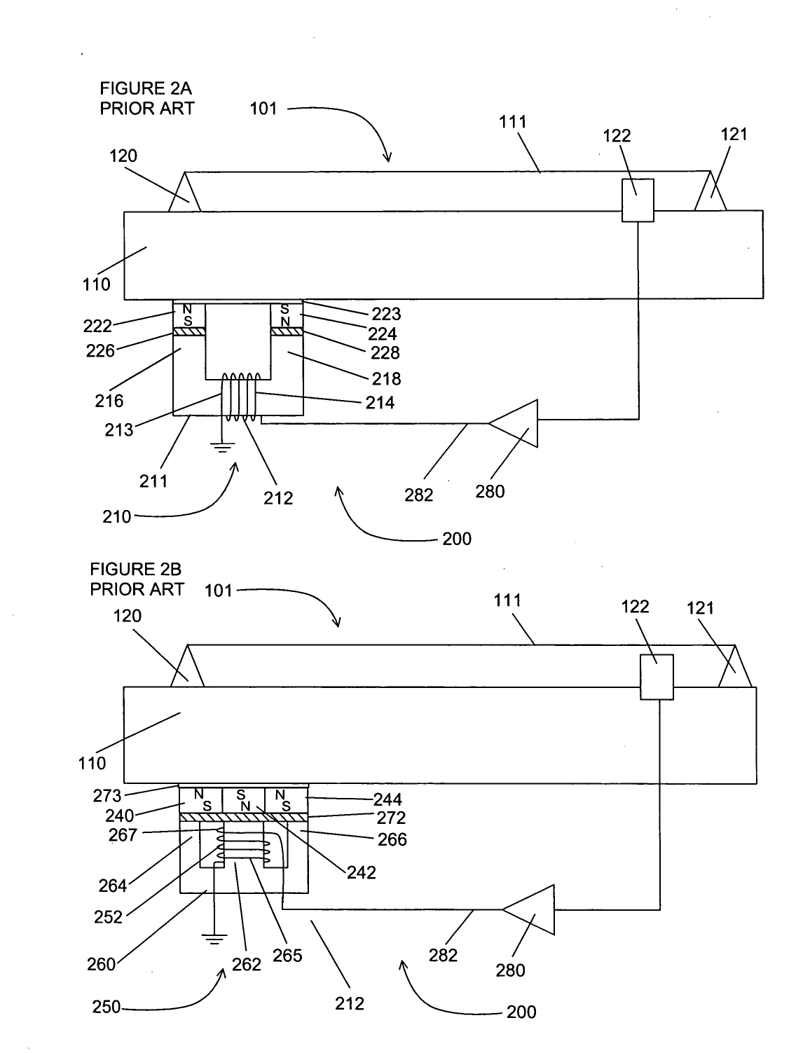

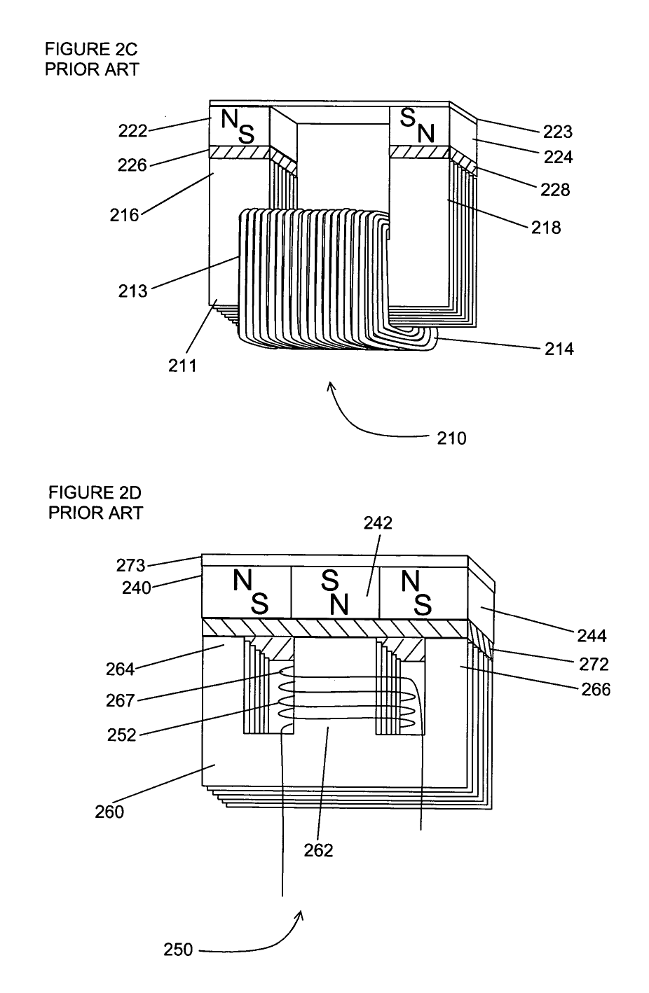

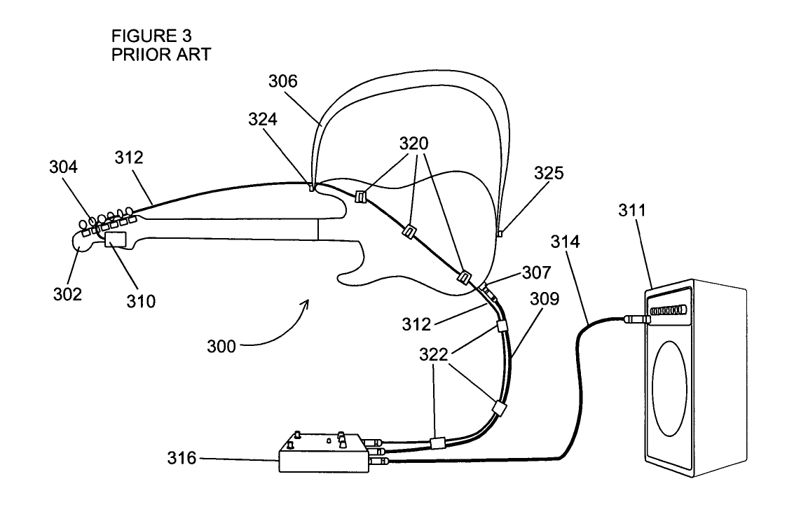

### DESCRIPTION

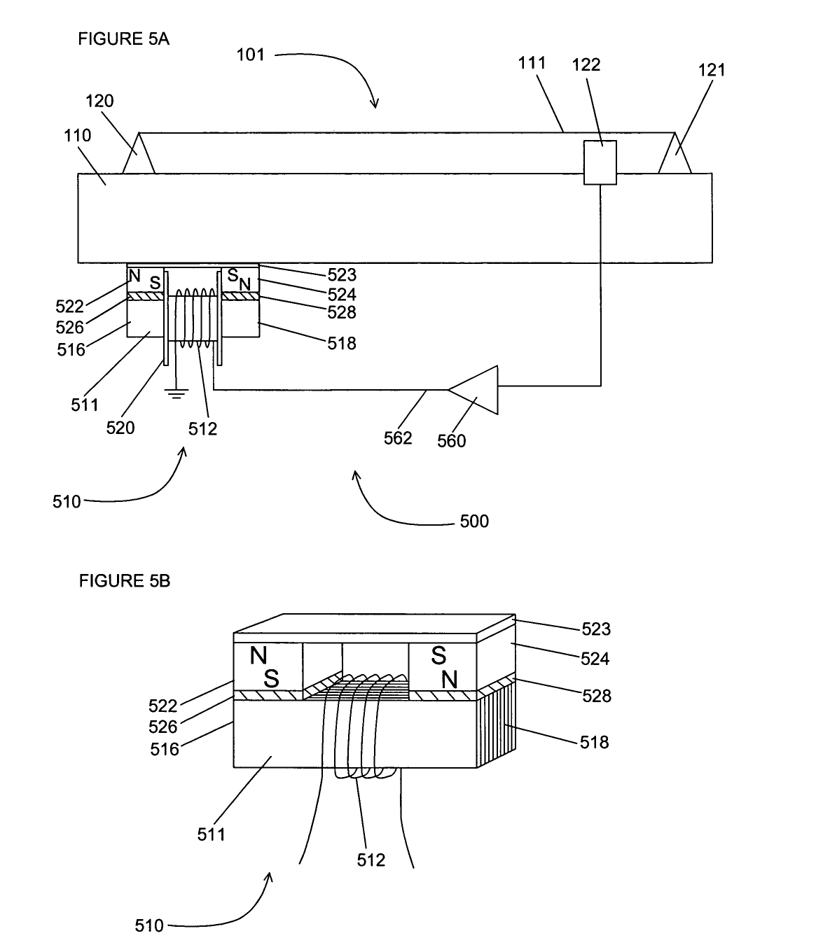

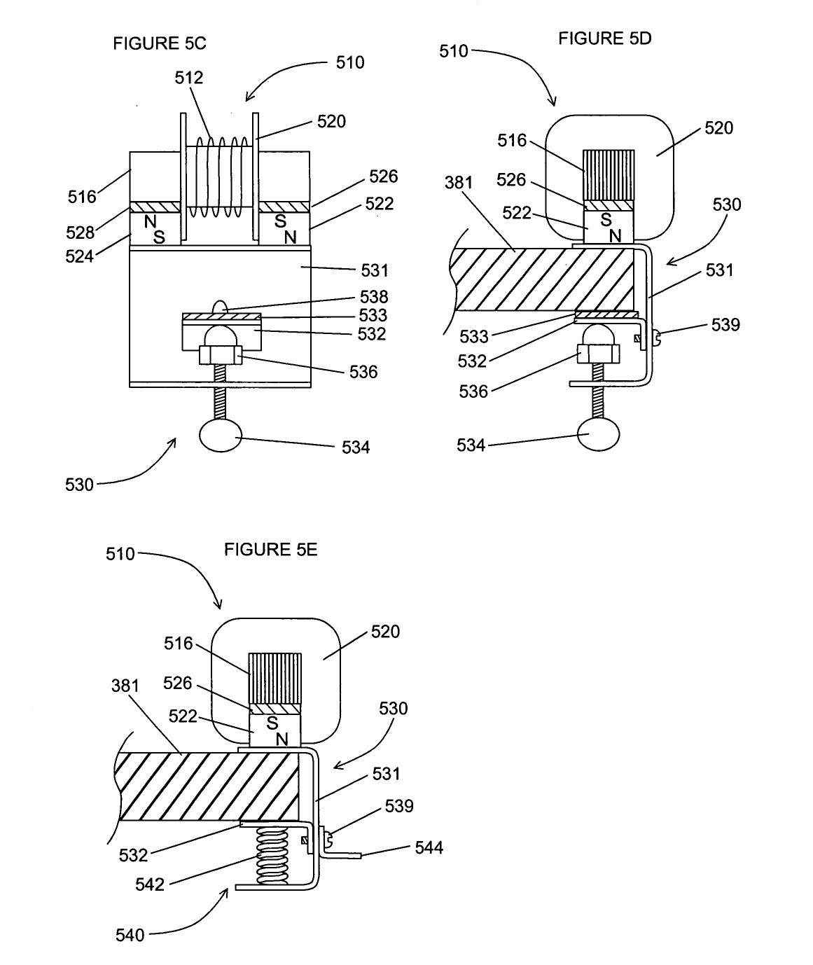

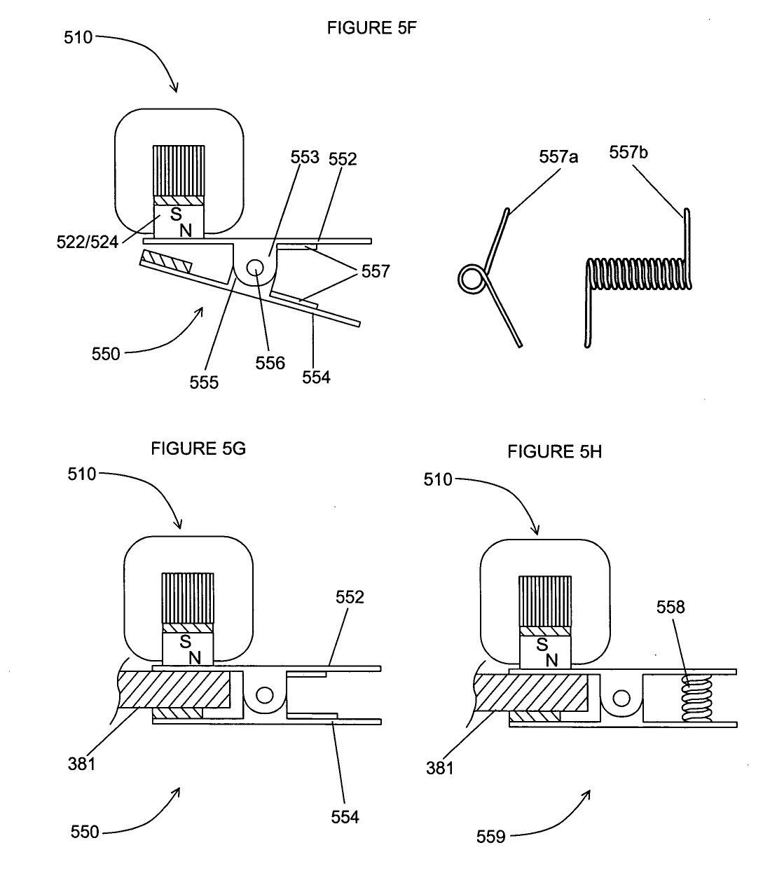

FIGS. 5A-5H: Improved Driver Transducer for an Acoustic Feedback Type Sustainer

FIGS. 5A and 5B show an improved transducer design, having a minimum symmetrical arrangement of magnetic parts for reduced magnetic crosstalk and also having a simple, economical design.

Referring to FIG. 5A, musical instrument 101 comprises body 110, one or more strings or other vibratile elements 111 which vibrate to produce the musical tones of the instrument, pickup 122, which produces an electrical voltage in response to vibrations of strings 111. Strings 111 are stretched between supports 120 and 121. Sustainer 500 comprises the following elements: Sustainer controller/amplifier 560 amplifies the output of musical instrument pickup 122. Output 562 of amplifier 560 is connected to sustainer electromagnetic transducer 510.

Referring to FIGS. 5A and 5B, coil 512 is wound around bobbin 520. Bobbin 520 is optional, but its use makes manufacturing easier. (Bobbin 520 is not shown in FIG. 5B in order to better show the laminated construction of core 511.) Bobbin 520 is centered in the middle of I-shaped (rectangular parallelepiped) core 511. Preferably, core 511 comprises a stack of laminations of magnetic steel as is depicted in FIG. 5B. Alternatively, the transducer would function with a solid steel core, a hard ceramic ferrite core, or even a permanent magnet core, such as alnico. As is well known in the art, laminated core construction results in less power dissipation than a solid core, because less eddy currents and magnetic hysteresis are produced in the core. Core ends 516, 518 protrude equal lengths from coil 512. Magnets 522, 524 are rigidly fastened to instrument body 110. The faces of magnets 522, 524 which are fastened to instrument body 110 are coplanar because magnets 522, 524 have substantially equal dimensions, and the sides of core 511 are preferably flat. The magnets can optionally be rigidly fastened to plate 523, preferably made from mild steel, which is then clamped or bonded rigidly to instrument body 110. The use of a steel plate as shown increases permanent magnet flux in core 511 and thus raises transducer efficiency. Also, plate 523 reduces radiated flux and therefore reduces magnetic crosstalk. Both magnets are preferably constructed of identical materials, and are of substantially identical size and shape. The preferred embodiment uses ceramic magnets, but other types would work also. The magnets are polarized according to the “N” and “S” markings shown in the drawing. The magnetic poles of each magnet face the resilient pads and body. The magnetic polarity can be opposite to that shown, as long as the directions of magnetization of the magnets are opposite to each other, and that the magnetic poles of the magnets face the core and are not rotated at right angles to the core.

Resilient pads 526, 528, similar in dimensions, are sandwiched between respective magnets 522, 524 and respective core ends 516, 518. Resilient pads 526, 528 are shown to be substantially equal in size to magnets 522, 524, but could be bigger or smaller without substantial effect on the driver performance. Preferably, when using a laminated core as shown in FIG. 5B, resilient pads 526, 528 would be sandwiched across the stack of lamination edges as shown, rather than across the flat side of a single lamination at the top or bottom of the stack as would be the case if core 511 was rotated 90 degrees about its long axis (not shown). The preferred core orientation as shown results in more efficient operation. The core portions across which a respective resilient pad is placed are defined as the “core faces”. (Of course, a single pad could straddle the coil and cover both core faces, but the use of two pads is the preferred embodiment.)

Output 562 of sustainer amplifier 560 is connected to coil 512. Current produced in coil 512 in response to amplifier 560 produces alternating magnetic flux in the core. During each alternating cycle of current, the alternating magnetic flux polarity in core ends 516, 518 alternately attracts and repels its respective magnet 522, 524, creating a vibrating magnetic force between magnets and respective core ends in response to the amplifier output signal. With the magnets being oppositely polarized as shown, the forces attract and repel both magnets simultaneously. Resilient pads 522, 524 allow core 511 and magnets 522, 524 to move with respect to each other in vibration in response to the alternating attractive/repulsive magnetic forces. The magnets vibrate in synchronization. Since both magnets are attached to respective core faces which point in the same direction, both magnets vibrate in synchronization in the same direction. Vibration energy travels from the magnets to the strings through optional plate 523, body 110, and string supports 120, 121. For the case of a fretted stringed instrument such as an electric guitar (not shown), vibration energy reaches the strings through the instrument frets. Since magnets 522, 524 are rigidly attached to instrument body 110, The magnetic fields radiated into free space at core ends 516, 518 are opposite in polarity but equal in amplitude and shape. They are symmetrical.

If optional plate 523 is used, it is important that magnets 522, 524 be rigidly attached to plate 523, and that plate 523 be rigidly attached to instrument body 110. These requirements insure that vibration energy be coupled from magnets to instrument body.

It can be appreciated by those skilled in the art that small changes could be made to the transducer described herein without changing the intent of the invention. For example, two coils could be placed side-by-side on core 511 and connected either in series or parallel (not shown). The transducer would still function as described and magnetic symmetry would be preserved. Furthermore, the core shape could be changed, to a curved or notched shape (not shown), and the transducer would still function as described and magnetic symmetry would be preserved. An additional pair of magnets/resilient pads could be used on the opposite side of the core as that shown. Two cores and two coils could be used, each core/coil associated with a single magnet. The important point is the symmetrical arrangement that produces zero net flux radiation in the far field, resulting in zero magnetic crosstalk.

The driver transducer of FIGS. 5A and 5B is more economical to produce than those of the U.S. Pat. No. 4,852,444 patent, yet produces very little magnetic crosstalk. This allows very high amplifier gain, resulting in very robust sustainer operation. Therefore, this driver transducer improves upon the prior art.

A driver transducer as described could be used for vibrating any body of mass, if it is driven by an appropriate alternating electrical power source.

FIGS. 5C-5H: Adding a Mounting Clamp to the Driver Transducer

FIGS. 5C and 5D depict mounting clamp 530 for transducer 510. FIG. 5C is a front view, and 5D is a side view. Clamp bracket 531 is preferably made of mild steel, which is bent to a “C” shape as shown in FIG. 5D. Clamp bracket 531 replaces plate 523 of FIGS. 5A and 5B. Movable piece 532 is also preferably constructed of mild steel, and bent to an “L” shape as shown in FIG. 5D. Oblong slot 538, shown partially obscured by piece 532 in FIG. 5C, is cut into bracket 531. Screw or rivet 539 holds piece 532 into slot 538. Screw or rivet 539 is not fully tightened, so that piece 532 is free to move in slot 538. Movable piece 532 slides in slot 538, so as to change the opening of the clamp. Clamp 530 is placed onto guitar headstock 381 as shown in FIG. 5D. Guitar headstock 381 is shown partially as a cutaway view. Movable piece 532 is adjusted with thumbscrew 534, such that headstock 381 is firmly clamped between bracket 531 and movable piece 532. Resilient sheet 533 is bonded to piece 530 in order to provide a stable friction mount so that clamp 530 will not slip off headstock 381. Plastic cap nut 536 provides a good pressure surface between thumbscrew 534 and piece 532. Magnets 522 and 524 mount directly to bracket 531. Bracket 531 is held tightly against headstock 381, and couples vibration energy into the headstock. Clamp 530 in combination with driver 510 provides a very useful combination for easy removal and attachment to an instrument such as an electric guitar. The key to the operation of this arrangement is that the clamp is rigidly mounted to vibrating magnets 522 and 524 by glue or the like, and therefore vibrates with them in response to current in coil 512, thereby transferring vibration energy from driver to instrument body such as a guitar headstock.

FIG. 5E depicts mounting clamp 540 for transducer 510. Mounting clamp 540 is similar to clamp 530, except that thumbscrew tightening mechanism has been replaced by spring 542. Sliding bracket 544 is provided so that hand pressure can be used to compress spring 542. Sliding bracket 544 is attached to movable piece 532 by screw or rivet 539. Compressing spring 542 opens the clamp by moving movable piece 532, allowing the clamp to be placed on guitar headstock 381. Spring 542 then holds clamp bracket 531 rigidly to guitar headstock 381. This allows vibrations from transducer 510 to be transferred to headstock 381. Spring 542 can be held in place by tabs (not shown), which are cut into bracket 531 and moveable piece 532 using a partial punch. Or, spring 542 could be welded or attached by other means to bracket 531 and moveable piece 532.

Another clamp mechanism 550 is depicted in FIGS. 5G and 5H. Clamp 550 is very similar to the familiar clipboard clamp that is used to hold stacks of paper in place. Two similar clamp brackets 552 and 554 fit together as shown. Each clamp bracket has two similar mounting tabs 553,555 that are formed by bending brackets 552, 554 at 90 degrees. Pin (or rivet or screw) 556 is inserted into holes that are punched into tabs 553, 555. This allows brackets 552, 554 to pivot around pin 556 in order to open clamp 550. Torsion spring 557 fits onto pin 556 (not shown). Detail drawings 557a and 557b show how the torsion spring is made. This is a very common type of clamp. Alternately, torsion spring 557 is sometimes seen replaced by a leaf spring mechanism (not shown). Another substitution that is often made to this type of clamp is to replace torsion spring 557 by compression spring 559, shown in FIG. 5H.

By rigidly mounting magnets 522/524 of transducer 510 to upper bracket 552 as shown, vibration energy is transferred to bracket 552. FIG. 5G shows how clamp 550 is mounted onto guitar headstock 381. Again, the key to the operation of this arrangement is that the clamp bracket is rigidly mounted to vibrating magnets 522 and 524, and therefore vibrates with them in response to current in coil 512, thereby transferring vibration energy from driver to instrument body.

The clamping mechanisms depicted in FIGS. 5C-5H improve upon the prior art by providing easy attachment and removal of a driver transducer from a musical instrument for electroacoustic-type sustainers, while still providing good coupling of driver vibration energy into the body or other part of a stringed musical instrument. It can be seen that any type of clamp will perform this function, as long as the transducer magnets are rigidly mounted to the clamp bracket and that also the clamp bracket is rigidly mounted to the instrument body, so that the magnets transmit vibration energy to the clamp bracket, and that the clamp bracket transmits vibration energy to the instrument body. This is the key to coupling the transducer vibrations to the instrument. The clamping mechanisms depicted in FIGS. 5C-5H all have at least one movable plate or piece which by means of spring pressure or a threaded screw or the like clamps the instrument or other body of mass to the clamp bracket securely, such that the plate or piece to which the transducer magnets are rigidly mounted is itself rigidly attached by clamping action to the instrument or other body of mass.

While not described herein, it can be readily seen to someone skilled in the art that the mechanics of the transducer could be reversed: The core could be rigidly attached or clamped to the instrument body or other body of mass, while the magnets are free to vibrate. This reverse orientation of the transducer elements would still transfer vibration energy from the transducer core to the instrument body or other body of mass. The transfer of vibration energy would be similar to that of the transducers depicted in FIG. 5 if the mass of the coil plus core is equal to that of the magnets.

The transducer thus described and depicted in FIG. 5 therefore improves upon the prior art, by providing an improved transducer for an electroacoustic-type sustainer. The improvements to the driver transducer are such that less magnetic field reaches the instrument pickup than with previous driver transducers, resulting in less magnetic crosstalk from driver to pickup. Consequently, sustainer amplifier gain can be set to a high level before uncontrolled oscillation occurs, resulting in more robust sustainer performance than has previously been possible. Furthermore, the transducer design is very simple in construction, using common parts, resulting in a very economical design. In addition, an improved transducer clamping mechanism is described that provides quick, easy attachment and removal of the driver transducer from the musical instrument, and also provides good vibration energy transfer from the driver transducer to the instrument body or other instrument part.

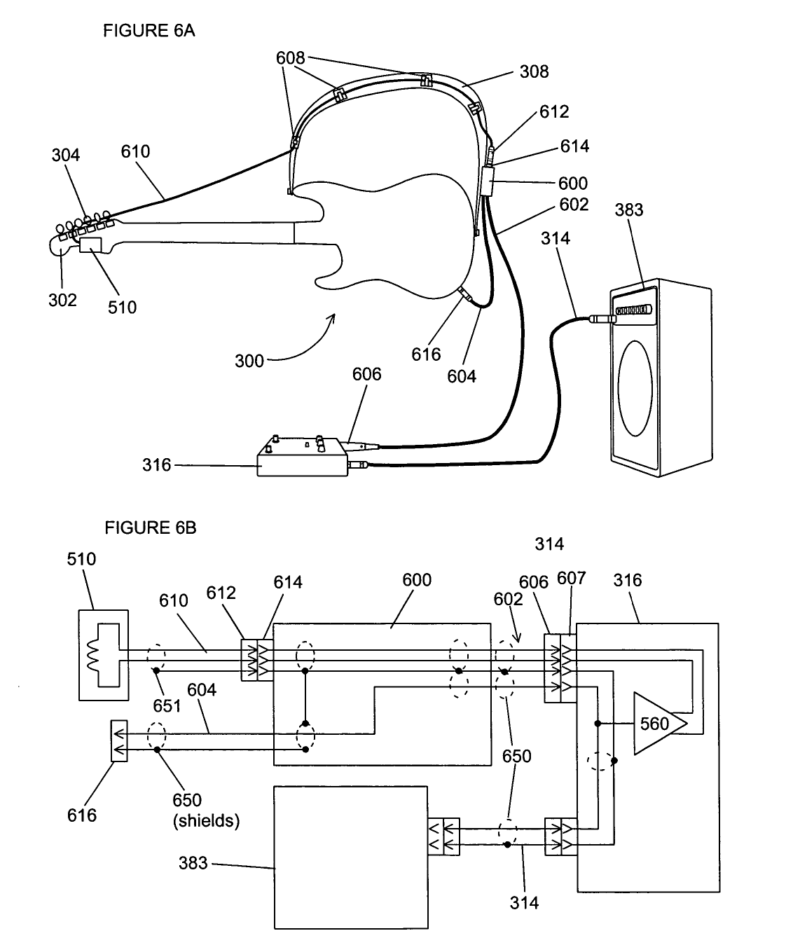

FIGS. 6A, 6B: Improved Cord Routing System for Electroacoustic Sustainer Driver Transducer

FIGS. 6A and 6B show an improved cord routing system, for connecting an electroacoustic sustainer driver transducer to the sustainer controller/amplifier. The cord routing system also connects the instrument output signal to a musical instrument amplifier. FIG. 6B is an electrical schematic, showing how the electrical conductors and connectors are used for signal routing and shielding. Electroacoustic driver transducer 510 is attached to headstock 302 of guitar 300. Transducer cord 610 is looped around tuning keys 304. Wire holders 608 are attached to guitar strap 308. Commonly available stick-on plastic wire clamps work very well in this application. Alternatively, a special strap could be made with loops or ties that hold cord 610, or with a tunnel that runs the length of the strap (not shown). Junction box or similar structure 600 is attached to guitar strap 308 by screws, clamp, or adhesive (not shown). An actual box could be dispensed with, and the cord junction itself could be attached to guitar strap 308 or to some other part of the instrument. Transducer cord 610 is held to clamps 608, allowing cord 610 to pass over the musician's shoulders with guitar strap 308. Transducer cord 610 preferably plugs into junction box 600 via normal guitar plug 612 or other type electrical connector. Such connectors are well known in the art. Mating jack 614 is mounted to junction box 600. Optionally, no connector is needed. But its use makes assembly/disassembly of the system easier. Guitar cord 604 is equipped with common guitar plug 616. No connector is needed to attach guitar cord 604 to junction box 600, although one could be used without substantially changing the cord routing system.

Multi-conductor shielded microphone-type cable 602 connects junction box 600 to sustainer amplifier/controller enclosure 316. Guitar cords are normally constructed from shielded cable to prevent noise pickup from ac line noise sources. Multi-conductor microphone-type cable 602 contains a shielded cable to carry the signal from the pickup (not shown) of electric guitar 300. Multi-conductor microphone-type cable 602 contains a second shielded cable to carry the transducer power signal, to shield it from the guitar pickup signal. This is necessary to prevent electrostatic crosstalk from the large transducer signal to the guitar pickup signal. If the transducer signal were not shielded, then noise would be coupled from the transducer signal to the guitar signal, or oscillation would occur. Multi-conductor connector 606 attaches cable 602 to jack 607 of sustainer amplifier/controller enclosure 316. Preferably, a common XLR-type mating connector set is used for this, but other connector types can be used.

In schematic FIG. 6B, transducer cable 610 and multi-conductor cable 602 are shown as 2-conductor, shielded pairs. Shield conductor 651 is not connected to transducer 510. It is actually routed to transducer 510 but left disconnected. The reason for this is that if shield 651 is connected to either inner conductor, shield 651 would carry current and voltage. This would obviate the function of the shield. By having shield 651 disconnected in this way, the shielding is effective for both electrostatic and electromagnetic radiation of the inner conductors. The sustainer might function without it, but this shielding scheme is preferable.

It can be seen that the actual junction box could be eliminated, by fastening only the joined cables directly to the guitar strap and the cord routing system would still function. However, the preferred arrangement as depicted and described is very convenient for use and also for assembly/disassembly of the system.

The cord routing system thus described and depicted in FIG. 6 therefore improves upon the prior art, by providing a single cable that routes the instrument signal from the instrument to the sustainer controller/amplifier enclosure, and also routes the sustainer transducer drive signal from the sustainer controller/amplifier enclosure to the sustainer transducer.

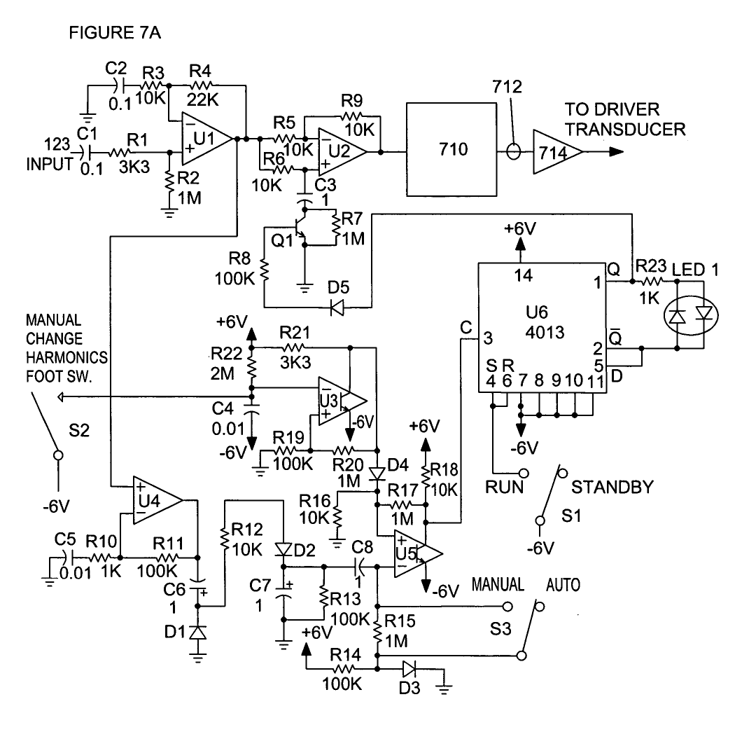

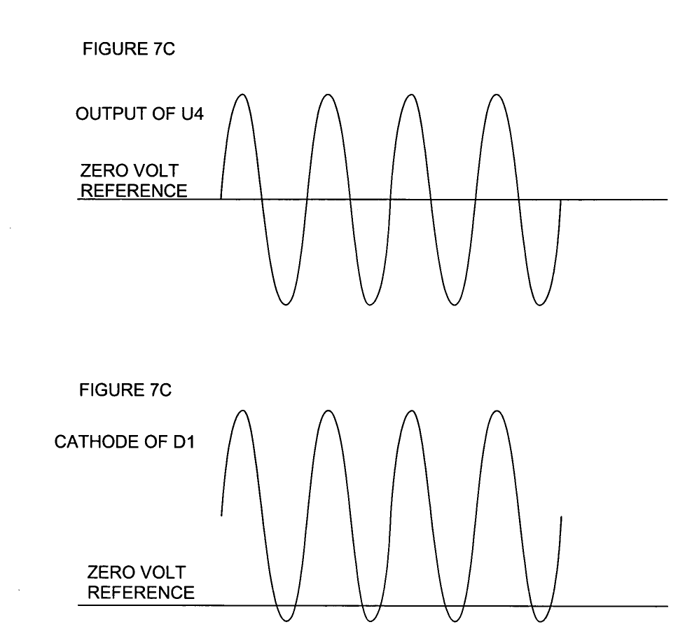

FIGS. 7A, 7B, 7C: Amplifier/Controller for Acoustic Feedback Sustainer, with Phase Reversal Circuit:

FIG. 7A shows the automatic phase reversal signal of the present invention. Resistance values are in ohms, capacitance values are in microfarads. Operational amplifiers (opamps) U1, U2, and U4 are typical operational amplifiers that are readily available, as are voltage comparators U3 and U5. These devices operate with +/−6 volts dc power supply in the present sustainer, although other supply voltages can be used. The opamps used are preferably TL084, although other devices can be used with very little or no difference in circuit performance. Comparators U3 and U5 are LM 393 although other devices can be used with very little or no difference in circuit performance. The comparators are shown with NPN transistors in their outputs, the output stages of the LM393 devices are actually open collector NPN.

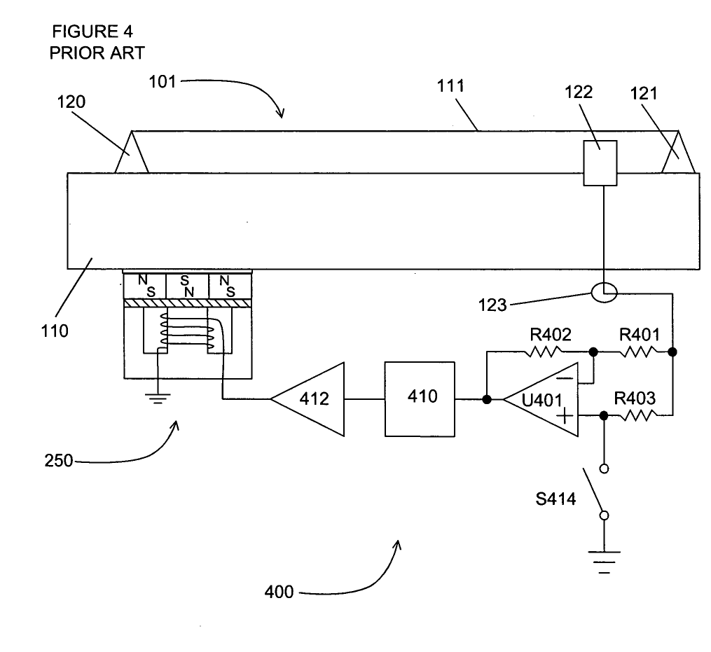

Pickup 122, as shown on the musical instrument of FIG. 4, produces an electrical signal 123 in response to vibrations of strings 111. Pickup output signal 123 is the input signal to the amplifier in FIG. 7A. This signal is amplified by operational amplifier U1 and associated passive components. Amplifier U1 is connected as a non-inverting voltage amplifier with gain of slightly over three for the values of R3, R4 shown. Capacitor C1 is used to reduce output offset voltage by making the gain unity for dc. R1 provides some electrostatic discharge protection to the amplifier input, and R2 provides a bias path for the amplifier input.

Operational amplifier U2 provides phase reversal capability, and is connected similar to that of U401 in FIG. 4. Bipolar NPN transistor Q1 functions as an electronic switch, to place amplifier U2 in inverting mode when Q1 is in the ON state, and in non-inverting mode when Q1 is in the OFF state. Q1 is controlled by the output of flip-flop circuit U6. U6 is preferably a 4013 type of CMOS flip-flop IC. Resistor R8 provides base current limiting, and diode D5 prevents base-emitter breakdown when the “Q” output (pin 1) of U6 is in the low state (−6 volts). Capacitor C3 is charged to the offset voltage of the noninverting terminal of U2 through resistor R7. This lessens the amplitude of transient voltages that are produced when Q1 switches on and off, thus preventing popping noises from being heard.

Switch S1 is preferably foot-operated. When switch S1 is in the position labeled “STANDBY”, pins 4 (SET) and 6 (RESET) are disconnected. This places pins 1 and 2 (“Q” and “Q” terminals) both at a logic high state. When S1 is in the “RUN” position, pins 4 and 6 are connected to −6 volts. This Allows the flip-flop circuit to function. A 2-color LED is shown connected across pins 1 and 2, and illuminates either red or green depending on whether the “Q” or “Q” terminal is high.

The output signal of amplifier U2 is processed by circuitry contained but not shown in detail in block 710. This circuitry includes frequency equalization circuitry and gain control circuitry. This circuitry is omitted because it is not new art, and its omission simplifies the diagram. The further processed signal 712 is then applied to the input of power amplifier 714. The output of power amplifier 714 is applied to the driver transducer (not shown).

Automatic Phase Reversal Circuit Function:

Operational amplifier U4 further amplifies the output signal of U1 with a gain of about 100, which is determined by the resistance valurs of R11 and R11. This gain value can vary somewhat. The signal at the output of U4 is shown in the oscillograph illustration in FIG. 7B. A dc clamp circuit comprising capacitor C6 and D1 processes the output of U4. This signal, at the cathode of diode D1, is shown in FIG. 7C. This alternating signal with positive dc offset is applied to dc rectifier circuit comprising R12, D2, and C7. The voltage at the (+) terminal of C7 is a dc voltage with amplitude equal to the peak-to-peak voltage of the signal of FIG. 5C minus the diode drop voltages of D1 and D2. Resistor R13 provides a discharge path for C7. The discharge time constant of R13/C7 is about 100 milliseconds for the component values shown. This dc voltage is applied to the inverting terminal of voltage comparator U5, after passing through a differentiator circuit comprising C8 and R15. The differentiator time constant is about one second for the component values shown. The inverting terminal of U5 is biased to about 0.6 volts by the combination of R14/D3. The noninverting terminal of U5 is biased at zero volts by R16. The time constants can be changed slightly without adverse effect on overall circuit performance.

At quiescent conditions with no input signal, the voltage on C7 is zero volts, and the voltage at the inverting input of U5 remains at 0.6 volts. This condition causes the output voltage of U5 output to be −6 volts, because the inverting terminal is at a more positive voltage than the noninverting terminal.

When a note is played, C7 begins charging through R12, a 10K resistor. This quickly charges C7 to a voltage determined by the amplitude of the signal at the output of U4. While C7 is charging, the voltage at the inverting input of U5 momentarily rises to a more positive value than the 0.6 volt quiescent condition as differentiator capacitor C8 charges up through R15. If the string vibration is successfully sustaining (meaning that vibration energy arriving at the upper string end from transducer 250 is not 180 degrees out of phase with the string vibration, which would stop its vibration quickly), then the voltage on the inverting input of U5 will drop back to the 0.6 volt quiescent value as C8 charges up.

But, if the string vibration sustain is not successful (vibration energy coming from transducer 250 is approximately 180 degrees out of phase with the string vibration at the upper end point of the string), then the following sequence will occur: The voltage on C7 will quickly charge to some positive value as instrument string 111 is initially plucked. C8 will begin charging. As the note quickly dies out, differentiator network C8/R15 will place a negative voltage at the inverting input of U5 because C8 cannot discharge quickly due to the large value of R15. If this negative voltage is great enough to cause the voltage at the inverting input of U5 to change to a value less than zero volts, then the output of comparator U5 will quickly change state from a logic low (−6 volts) to a logic high (+6 volts). Providing positive feedback from output to noninverting input of U5 by R17 insures a fast transition. This positive-going change of state triggers the clock terminal of U6, pin 3. This toggles the flip-flop, and the “Q” output (pin 1) changes state from a logic low to a logic high. This turns on Q1 through D5 and R8. U2 now changes its configuration from a noninverting amplifier to an inverting one. Now, the vibration energy that couples into the string upper ends from the driver is in phase with the string vibrations, and sustained vibration quickly builds up.

It is also desirable to have a manual phase reversal switch, which can be controlled by the musician's foot. Voltage comparator U3 is used in conjunction with switch S2 to manually change phase. Switch S2 is preferably a foot-operated momentary pushbutton type switch. Capacitor C4 is charged to +6 volts in normal operation of the sustainer, placing +6 volts on the inverting input terminal of comparator U3. This forces the output of U3 to go to −6 volts. The noninverting terminal is nominally placed at zero volts.

Switch S3 is used to place the harmonic mode switching in “manual” or “automatic” mode. S3 can be a slide or toggle type switch, or it can be a foot-controlled switch. In “automatic” position, the automatic phase reversal circuit still functions, but the musician can force a harmonic change by using the foot-controlled switch. In “manual” position, R15 is shorted out. This prevents the voltage from differentiator from affecting the voltage at the inverting terminal of U5. In “manual” position, phase reversal can only be effected by actuating switch S2. The 0.6 volts on the anode of D3 is present at the inverting terminal at all times.

In developing the automatic phase reversal circuit, the inventor noticed while playing a guitar while using the sustainer, that another benefit resulted from its use: The musician can willfully cause phase reversal (and string vibration harmonic change) by lightly touching a vibrating string, or by slightly reducing fretting pressure on a vibrating string. This simple hand-muting technique causes the played note to quickly reduce its amplitude, which triggers the automatic phase reversal circuit. By carefully controlling the manual partial muting of the string so as not to completely mute the note, the musician can maintain the string vibration and change the harmonic at will. This allows the musician to force string vibration harmonic changes without using the foot-switch on the floor-box controller. Consequently, the musician is free to move about the stage, and doesn't need to remain within reach of the sustainer housing. This is a new technique, not previously possible.

Thus, the automatic phase reversal circuit improves upon the prior art, by providing a solution to the problem with dead notes with an acoustic-type sustainer. It also provides a new automatic means to select different harmonic modes of sustainer operation, allowing the musician to change sustained string vibration harmonics at will by a simple playing technique, eliminating the need to remain fixed at a position near the sustainer controller/amplifier enclosure.

### Conclusion and Scope

To summarize the above description, the sustainer described and depicted can be seen to advance the state of the art of an electroacoustic-type sustainer, comprising the following elements:

An improved driver transducer was described, having simple, economical construction, which provides reduced electromagnetic crosstalk to the pickup of an electric musical instrument. This results in an electroacoustic-type sustainer having a more robust performance than has previously been available;

An acoustic-type sustainer having an improved transducer clamping mechanism that simultaneously provides quick, easy attachment and removal of the driver transducer from the musical instrument, and also provides good vibration energy transfer from the driver transducer to the instrument body or other instrument part;

An acoustic-type sustainer having an improved cord routing system for routing the transducer power signal and also the instrument output signal through a single cable to the sustainer control box that is less cumbersome than the prior art, wherein both the musical instrument pickup signal and the sustainer transducer drive signal are routed from the instrument via a single electrical cable;

An acoustic-type sustainer having an automatic circuit to effect phase-reversal of the amplifier signal at the will of the musician, without the necessity of actuating any hand-controlled or foot-controlled electromechanical switch, in order to provide better control of the instrument string harmonics by the musician than has previously been possible.

While my above description contains many specificities, these should not be construed as limitations on the scope of the invention, but rather as an exemplification of one preferred embodiment thereof. Thus the scope of the invention should be determined by the appended claims and their legal equivalents, rather than by the examples given.

Accordingly, the scope of the invention should be determined not by the embodiments illustrated, but by the appended claims and their legal equivalents.

1. An electroacoustic transducer for vibrating part of the body of a musical instrument,
wherein said musical instrument body has at least one solid surface on which to mount said transducer, said transducer comprising:
(a) a core made of magnetic steel or other magnetic material;
(b) a coil of electrically conductive wire wound around said core;
(c) two or more permanent magnets;
(d) one or more sheets of resilient material;
wherein said core protrudes from both ends of said coil such that substantially equal lengths, widths, heights, and shapes of said core protrude from both ends of said coil forming a symmetrical arrangement of core with respect to coil,
wherein said protruding core has at least two similar faces, one or more said faces being on one side of said coil and an equal number of corresponding said faces being on the other side of said coil, comprising a symmetrical arrangement of core faces about said coil,
wherein a said resilient sheet or sheets are sandwiched between each said respective core face and a said respective permanent magnet pole,
wherein each pair of said magnets adjacent to corresponding core faces are of substantially equal size and shape so as to form a symmetrical arrangement of magnets, sheets, and core faces about said core,
wherein connection of said coil or said electrical cable to an audio frequency signal source produces said transducer drive signal, resulting in an alternating current in said coil, wherein said alternating current induces an alternating magnetic flux in said core,
wherein said magnets and core vibrate with respect to each other in response to magnetic forces that result from said magnetic flux,
wherein the opposite permanent magnet poles from those mounted to said resilient sheet or sheets are rigidly attached onto a surface of said body of said musical instrument which is to be vibrated, or instead, said core is rigidly attached onto a surface of said body of said musical instrument,
wherein said musical instrument body is vibrated in response to said audio frequency current being produced in said coil.

2. The transducer of claim 1, wherein the said opposite permanent magnet poles from those mounted to said resilient sheets are mounted onto one surface of a plate, and wherein an opposing surface of said plate is rigidly mounted to said body of said musical instrument which is to be vibrated by said transducer.

3. The transducer of claim 1, wherein a body of mass is substituted for a musical instrument body.

4. The transducer of claim 2, wherein a body of mass is substituted for a musical instrument body.

5. The transducer of claim 2, wherein said plate is one side of a clamp means having two opposing sides, at least one of said two opposing sides being movable so as to firmly clamp a part of a body of said musical instrument or other body of mass between said two opposing sides of said clamp means.

6. A conductor routing means for combining first and second electrical signals through a single multi-conductor electrical cable,
wherein said first signal is the output signal of a musical instrument, and said second signal is a transducer drive signal, wherein the function of said transducer is to vibrate a body of said musical instrument, said transducer being mounted to the body of said instrument;
wherein said musical instrument output signal is applied to the input of an amplifier for an electroacoustic musical instrument sustainer, wherein said amplifier for said sustainer can be physically separate from said musical instrument, wherein the output of said sustainer amplifier is said transducer drive signal;
wherein a first signal conductor which carries said first signal joins to a first conductor of said multi-conductor electrical cable and wherein said second signal cable carrying said second signal joins to a second conductor of said multi-conductor electrical cable;
wherein said junctions of said first and second signal conductors to respective said first and second conductors of said multi-conductor cable are attached to said instrument.

7. The conductor routing means of claim 6, wherein said junctions of said first and second signal conductors to respective said first and second conductors of said multi-conductor cable are attached to a structure that is attached to said instrument.

8. The conductor routing means of claim 6, wherein said second signal conductor is attached to a musical instrument strap, wherein said strap is used to carry said instrument.

9. The conductor routing means of claim 8, wherein said strap has built-in cord attachment means.

10. A controller/amplifier circuit for a musical instrument sustainer, said musical instrument having at least one vibratile element which produces the sound of said instrument, said instrument also having a pickup for sensing the vibrations of said vibratile elements, wherein said pickup produces a pickup electrical signal in response to vibrations of said vibratile element or elements, wherein said pickup electrical signal is the input signal to said controller/amplifier, said controller/amplifier comprising:
(a) at least one amplifier circuit to amplify said pickup signal;
(b) at least one signal processing circuit to process said pickup signal, wherein one said signal processing circuit is an automatic phase reversal circuit;
(c) an output which drives a transducer for said musical instrument sustainer;
wherein phase reversal of said signal causes a change in vibration harmonics of said vibratile elements of said instrument,
whereby automatic phase reversal of said signal occurs when said pickup signal amplitude changes from a first amplitude to another, lesser amplitude, such that said change between said first amplitude and said lesser amplitude must exceed a predetermined rate of change,
wherein if said rate of change between said first amplitude and said second amplitude is less than said predetermined difference, said automatic phase reversal will not occur, but wherein if said rate of change between said first amplitude and said second amplitude is equal to or greater than said predetermined difference, then said automatic phase reversal will occur.
